(19) United States
(12) Patent Application Publication
(10) Pub. No.: US 2018/0084884 A1
(43) Pub. Date: Mar. 29, 2018

(54) Lighted Wallet Assembly

(71) Applicant: Stephanie Draper, Birmingham, AL (US)

(72) Inventor: Stephanie Draper, Birmingham, AL (US)

(21) Appl. No.: 15/278,237

(22) Filed: Sep. 28, 2016

(51) Int. Cl. A45C 15/06; A45C 1/06; A45C 13/10; F21V 33/00; F21V 23/04; F21L 4/00

(52) U.S. Cl. CPC A45C 15/06; A45C 1/06; A45C 13/103; A45C 13/1092; F21Y 2115/10; F21V 23/0442; F21L 4/00; A45C 2001/065; A45C 2013/1015; F21V 33/0004

(57) ABSTRACT

A light emitting wallet assembly includes a panel that has a first side, a second side and a perimeter edge. The perimeter edge includes a first lateral edge and a second lateral edge. The panel has a fold line therein extending between the first and second lateral edges to allow the panel to be folded into a closed position. A pocket is positioned on the second side for holding money. A plurality of sleeves is mounted on the second side for holding a bank cards. A light emitting device is mounted on the second side and is configured to emit light. The light emitting device is turned on when an angle in the fold line is greater than 135° and is turned off when the angle is less than 5°.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to wallet devices and more particularly pertains to a new wallet device which emits light when the wallet is being used so that money, cards and other articles accessed from the wallet are easily viewable.

### BRIEF SUMMARY OF THE INVENTION

An embodiment of the disclosure meets the needs presented above by generally comprising a panel that has a first side, a second side and a perimeter edge. The perimeter edge includes a first end edge, a second end edge, a first lateral edge and a second lateral edge. The panel has a fold line therein extending between the first and second lateral edges to allow the panel to be folded into a closed position such that a first portion of the second side can face a second portion of the second side. A pocket is positioned on the second side and is configured for holding money. A plurality of sleeves is mounted on the second side and each of the sleeves is configured for holding a bank card. A light emitting device is mounted on the second side and is configured to emit light. The light emitting device is turned on when an angle in the fold line is greater than 135° and is turned off when the angle is less than 5°.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective top view of a light emitting wallet assembly according to an embodiment of the disclosure.

FIG. 2 is a bottom view of an embodiment of the disclosure.

FIG. 3 is a front view of an embodiment of the disclosure.

FIG. 4 is a cross-sectional view of an embodiment of the disclosure taken along line 4-4 of FIG. 3.

FIG. 5 is a side view of an embodiment of the disclosure.

FIG. 6 is a front perspective view of an embodiment of the disclosure.

### DETAILED DESCRIPTION OF THE INVENTION

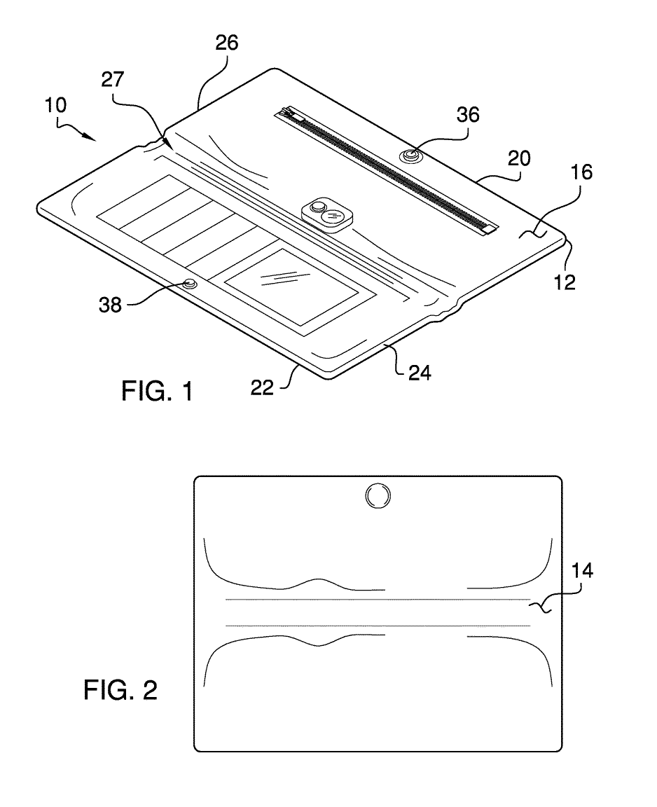

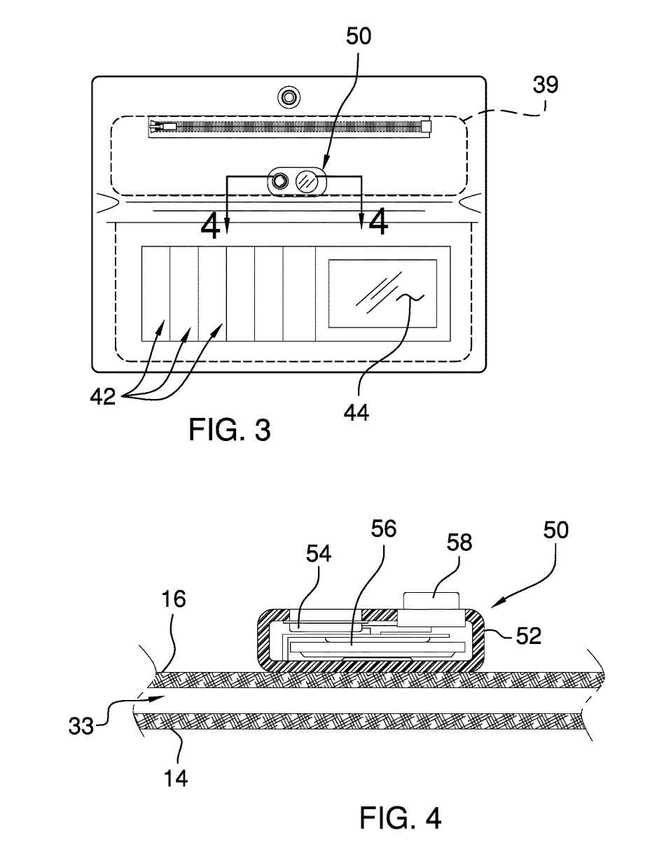

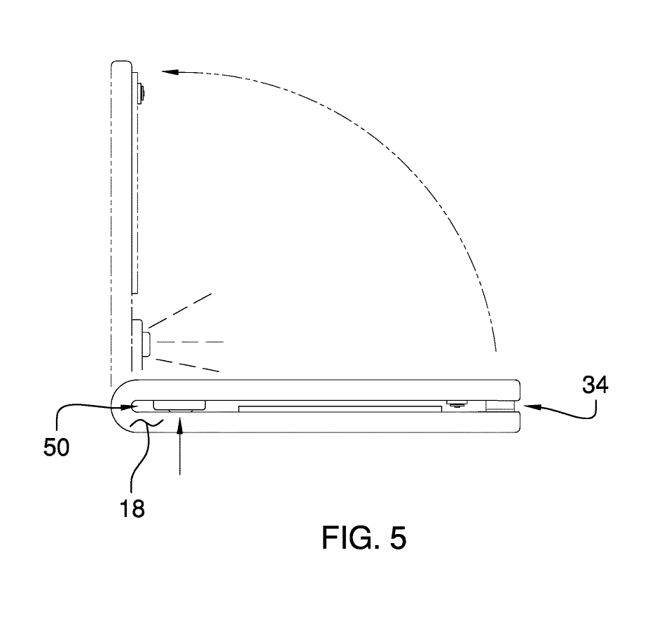

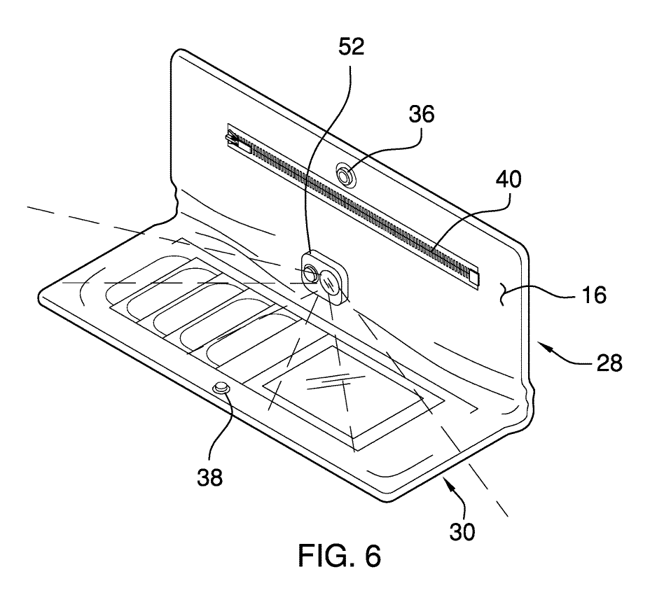

With reference now to the drawings, and in particular to FIGS. 1 through 6 thereof, a new wallet device embodying the principles and concepts of an embodiment of the disclosure and generally designated by the reference numeral 10 will be described.

As best illustrated in FIGS. 1 through 6, the light emitting wallet assembly 10 generally comprises a panel 12 that has a first side 14, a second side 16 and a perimeter edge 18. The perimeter edge 18 includes a first end edge 20, a second end edge 22, a first lateral edge 24 and a second lateral edge 26. The panel 12 has a fold line 27 therein extending between the first 24 and second 26 lateral edges to allow the panel 12 to be folded into a closed position such that a first portion 28 of the second side 16 faces a second portion 30 of the second side 16. The panel 12 may have a length and width each being less than 7.0 inches. It should be understood that the panel 12 may have two or three fold lines each being parallel with the fold line 27 and thus the panel 12 will typically have the first end edge 20 being less than 7.0 inches though the first 20 and second 22 lateral edges may have lengths up to 10.0 inches. However, the panel 12 will typically have a smaller size to more easily fit into a pocket or a purse. The panel 12 may be comprised of any conventional material used for wallets including leather, synthetic leather, plastics, fabrics and the like. Additionally, the panel 12 may comprise multiple layers of panels 12 wherein cavities 33 may be formed between the panels 12 for holding money, bank cards and other articles. A closure 34 is mounted on the panel 12 and releasably retains the panel 12 in the closed position. The closure 34 may include a first mating member 36 attached to the first portion 28 and a second mating member 38 attached to the second portion 30. The closure 34 may comprise a snap though other fasteners such as hook and loop fasteners, zippers and the like may be utilized.

A pocket 39 is positioned on the second side 16 and is configured for holding money. The pocket 39 may be a pocket formed on the second side 16 or between the first 14 and second 16 sides within the cavity 33. The pocket 39 may be positioned between the fold line 27 and the first end edge 20. A zipper 40, snap, hook and loop closure, or other closing member may be utilized to close the pocket 38. A plurality of sleeves 42 is mounted on the second side 16. Each of the sleeves 42 is configured for holding a bank card or articles of similar dimensions such as identification cards. The plurality of sleeves 42 may be positioned between the fold line 27 and the second end edge 22. One of the sleeves 42 may include a window 44 of transparent material to allow reading of the article within that sleeve 42.

A light emitting device 50 is mounted on the second side 16 and is configured to emit light. The light emitting device 50 is turned on when an angle in the fold line on the second side 16 is greater than 135° and the light emitting device 50 is turned off when the angle is less than 5°. These angles are a maximum and a minimum only, respectively. Thus, the light emitting device 50 may be set to be turned on or off anywhere between the 5° angle and the 135° angle. The light emitting device 50 comprises a housing 52 that is mounted on the panel 12. A light emitter 54, such as a light emitting diode, is mounted on the housing 52 and directs light away from the second side 16 when the light emitter 54 is turned on. A battery 56 is electrically coupled to the light emitter 54 and is mounted in the housing 52. A switch 58 is mounted on the housing 50 and is electrically coupled to the battery 56. The switch 58 retains the light emitter 54 in an off condition when the angle is less than 5° and the switch 58 retains the light emitter in an on condition when the angle is greater than 135°. The switch 58 may be a pressure switch that turns the light emitter 54 off when depressed and on when the switch 58 is released.

In use, the assembly 10 is used in a conventional manner to hold personal articles such as money, bank cards, identification cards and the like. However, when a person opens the panel 12, the light emitting device 50 turns on and illuminates the areas around the sleeves 42 and the pocket 39 to allow a person to easily see the contents thereof. The light emitting device 50 also allows facilitates the ability of the user inspect items removed from the panel 12 or inserted into the panel 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal wallet and light combination assembly configured for holding money and bank cards, said assembly comprising:
a panel having a first side, a second side and a perimeter edge, said perimeter edge including a first end edge, a second end edge, a first lateral edge and a second lateral edge, said panel having a fold line therein extending between said first and second lateral edges to allow said panel to be folded into a closed position such that a first portion of said second side can face a second portion of said second side;
a pocket being positioned on said second side and being configured for holding money;
a plurality of sleeves being mounted on said second side, each of said sleeves being configured for holding a bank card; and
a light emitting device being mounted on said second side and being configured to emit light, said light emitting device being turned on when an angle in said fold line is greater than 135°, said light emitting device being turned off when said angle is less than 5°.

2. The personal wallet and light combination assembly according to claim 1, wherein said panel has a length and width each being less than 7.0 inches.

3. The personal wallet and light combination assembly according to claim 1, said pocket is positioned between said fold line and said first end edge and said plurality of sleeves is positioned between said fold line and said second end edge.

4. The personal wallet and light combination assembly according to claim 1, wherein said light emitting device is turned on when an angle in said fold line is greater than 135°, said light emitting device is turned off when said angle is less than 5°, said light emitting device comprising.

5. The personal wallet and light combination assembly according to claim 1, wherein said light emitting device comprises:
a housing being mounted on said panel;
a light emitter being mounted on said housing and directing light away from said second side when said light emitter is turned on;
a battery being electrically coupled to said light emitter;
a switch being mounted on said housing and being electrically coupled to said battery.

6. The personal wallet and light combination assembly according to claim 4, wherein said light emitting device comprises:
a housing being mounted on said panel;
a light emitter being mounted on said housing and directing light away from said second side when said light emitter is turned on;
a battery being electrically coupled to said light emitter;
a switch being mounted on said housing and being electrically coupled to said battery, said switch retaining said light emitter in an off condition when said angle is less than 5°, said switch retaining said light emitter in an on condition when said angle is greater than 135°.

7. The personal wallet and light combination assembly according to claim 1, further including a closure being mounted on said panel, said closure releasably retaining said panel in said closed position.

8. The personal wallet and light combination assembly according to claim 7, further including said closure comprising a first mating member attached to said first portion and a second mating member attached to said second portion.

9. A personal wallet and light combination assembly configured for holding money and bank cards, said assembly comprising:
a panel having a first side, a second side and a perimeter edge, said perimeter edge including a first end edge, a second end edge, a first lateral edge and a second lateral edge, said panel having a fold line therein extending between said first and second lateral edges to allow said panel to be folded into a closed position such that a first portion of said second side faces a second portion of said second side, said panel having a length and width each being less than 7.0 inches;
a pocket being positioned on said second side and being configured for holding money, said pocket being positioned between said fold line and said first end edge;
a plurality of sleeves being mounted on said second side, each of said sleeves being configured for holding a bank card, said plurality of sleeves being positioned between said fold line and said second end edge;
a light emitting device being mounted on said second side and being configured to emit light, said light emitting device being turned on when an angle in said fold line is greater than 135°, said light emitting device being turned off when said angle is less than 5°, said light emitting device comprising;
a housing being mounted on said panel;
a light emitter being mounted on said housing and directing light away from said second side when said light emitter is turned on;
a battery being electrically coupled to said light emitter;
a switch being mounted on said housing and being electrically coupled to said battery, said switch retaining said light emitter in an off condition when said angle is less than 5°, said switch retaining said light emitter in an on condition when said angle is greater than 135°; and
a closure being mounted on said panel, said closure releasably retaining said panel in said closed position, said closure including a first mating member attached to said first portion and a second mating member attached to said second portion.
